(19) United States
(12) Patent Application Publication
(10) Pub. No.: US 2012/0090246 A1
(43) Pub. Date: Apr. 19, 2012

(54) Refrigerator/freezer door, and/or method of making the same

(75) Inventors: Jose Nunez-Regueiro, Ann Arbor, MI (US); Jim St. Jean, Canton, MI (US)

(73) Assignee: Guardian Industries Corp., Auburn Hills, MI (US)

(21) Appl. No.: 12/923,953

(22) Filed: Oct. 15, 2010

(51) Int. Cl. F25D 23/02; C03C 27/06; E06B 7/16

(52) U.S. Cl. 49/484.1; 156/109

(57) ABSTRACT

Certain example embodiments of this invention relate to refrigerator/freezer doors that include three substantially parallel, spaced apart glass substrates that effectively form two insulating glass units (IGUs), and/or methods of making the same. The substrates in the two IGUs have one or more surfaces coated with a low emissivity coating and also have one or more other surfaces coated with an antireflective coating. In certain example embodiments, one or more of the substrates may be low-iron substrates. For instance, certain example embodiments may include a center substrate that has an antireflective coating disposed on both major surfaces, whereas the outer substrates have low-E coatings disposed on inner surfaces thereof. Advantageously, certain example embodiments combine high energy efficiency with high light transmission.

### FIELD OF THE INVENTION

Certain example embodiments of this invention relate to refrigerator/freezer doors, and/or methods of making the same. More particularly, certain example embodiments of this invention relate to refrigerator/freezer doors that include two insulating glass units (IGUs), with the substrates comprising those IGUs having one or more surfaces coated with a low emissivity coating and one or more other surfaces coated with an antireflective coating, and/or methods of making the same. In certain example embodiments, one or more of the substrates may be low-iron substrates.

### BACKGROUND AND SUMMARY OF EXAMPLE EMBODIMENTS OF THE INVENTION

Existing refrigerated merchandisers display food products in a product display area. In order to reduce the amount of heat entering the refrigerated area, they include glass doors that also provide visibility and accessibility to consumers. Because glass is a poor thermal insulator, such doors often include two or three separates panes of glass with one or two spaces between them to increase the thermal insulation of the door. Thus, current refrigerator doors may be thought of as including one or two insulating glass units (IGUs).

Moisture is known to condense on refrigerator/freezer doors and other glass products. Condensation buildup on refrigerator/freezer doors in supermarkets or the like sometimes makes it difficult for shoppers to quickly and easily pinpoint the products that they are looking for.

Various anticondensation products have been developed over the years to address these and/or other concerns in a variety of applications. See, for example, U.S. Pat. Nos. 6,818,309; 6,606,833; 6,144,017; 6,052,965; 4,910,088, the entire contents of each of which are hereby incorporated herein by reference. Certain approaches use active heating elements to reduce the buildup of condensation, for example, as in actively heated refrigerator/freezer doors, etc. In the case of refrigerator/freezer doors, such active solutions may be expensive and/or energy inefficient.

Because of the present-day need for increased energy efficiency of refrigerated display systems, increased thermal insulation of the IGU sometimes is achieved by using low-emissivity (low-E) coatings on one or more of the inner surfaces of the IGU. Unfortunately, however, one undesirable consequence of this approach involves the rapid loss of light transmission through the IGU as more glass panes and more low-E coatings are incorporated. This, in turn, results in diminished marketing value of the door.

Thus, it will be appreciated that there is a need in the art for increasing the energy efficiency of the IGUs that make up refrigerator doors while at the same time increasing the visible light transmission through it, and methods of making the same.

In certain example embodiments of this invention, a refrigerator/freezer door is provided. First, second, and third glass substrates are provided. A first edge seal is provided at a periphery of the first and/or second substrate(s) to help maintain the first and second substrates in substantially parallel, spaced apart relation to one another. A second edge seal is provided at a periphery of the second and/or third substrate(s) to help maintain the second and third substrates in substantially parallel, spaced apart relation to one another. First and second antireflective coatings are respectively supported by first and second major surfaces of the second substrate. First and second low-E coatings are respectively supported by major surfaces of the first and third substrates that face the second substrate. At least one of the first, second, and third glass substrates is a low-iron substrate.

In certain example embodiments of this invention, a refrigerator/freezer door is provided. First, second, and third glass substrates are provided. A first edge seal is provided at a periphery of the first and/or second substrate(s) to help maintain the first and second substrates in substantially parallel, spaced apart relation to one another. A second edge seal is provided at a periphery of the second and/or third substrate(s) to help maintain the second and third substrates in substantially parallel, spaced apart relation to one another. At least one antireflective coating is provided, with each said antireflective coating being supported by one major surface of the second substrate. At least one low-E coating is provided, with each said low-E coating being supported by one major surface of the first or third substrate. At least one of the first, second, and third glass substrates comprises low-iron glass including the following ingredients at the following weight percentages:

| Ingredient | wt. % |
|---|---|
| SiO2 | 67-75% |
| Na2O | 10-20% |
| CaO | 5-15% |
| total iron (expressed | 0.001 to 0.1% |
| as Fe2O3) | |
| % FeO | 0 to 0.005 |

wherein the low-iron glass has a visible transmission of at least about 90%, a transmissive a* color value of −1.0 to +1.0, and a transmissive b* color value of from −0.50 to +1.5, and wherein the refrigerator/freezer door has a visible transmission of at least about 55%.

In certain example embodiments of this invention, a method of making a refrigerator/freezer door is provided. First, second, and third glass substrates are provided. First and second antireflective coatings are disposed, directly or indirectly, on first and second major surfaces of the second substrate, respectively. First and second low-E coatings are disposed, directly or indirectly, on major surfaces of the first and third substrates that face the second substrate, respectively. A first edge seal is provided at a periphery of the first and/or second substrate(s) to help maintain the first and second substrates in substantially parallel, spaced apart relation to one another. A second edge seal is provided at a periphery of the second and/or third substrate(s) to help maintain the second and third substrates in substantially parallel, spaced apart relation to one another. At least one of the first, second, and third glass substrates is a low-iron substrate.

The features, aspects, advantages, and example embodiments described herein may be combined to realize yet further embodiments.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 shows the spectral characteristics of single-sided and double-sided antireflective coatings on clear float glass in accordance with certain example embodiments;

FIG. 2 is a cross-sectional view of an article supporting a low-E coating according to an example embodiment of this invention; and

FIG. 3 is an example refrigerator/freezer door in accordance with an example embodiment.

### DETAILED DESCRIPTION OF EXAMPLE EMBODIMENTS OF THE INVENTION

Certain example embodiments relate to an insulated glass unit system for a refrigerated merchandiser that combines high energy efficiency with high light transmission. More particularly, certain example embodiments may incorporate antireflective (AR) coatings with or without low absorption glass substrates. Such low absorption glass substrates may be so-called low-iron substrates that have a low content of Fe and FeO.

To increase the visible transmission of the door, one or more panes of thereof may include a thin film single- or multi-layer antireflective coating. For example, in connection with a refrigerator door including two IGUs (and thus three glass substrates), antireflective coatings may be applied to any one or more of the six surfaces thereof. Antireflective coatings are described in, for example, U.S. Pat. Nos. 7,588,823; 6,589,658; and 6,586,102, as well as U.S. Publication Nos. 20090148709; 20090133748; 20090101209; 20090032098; and 20070113881, the entire contents of each of which are hereby incorporated herein by reference.

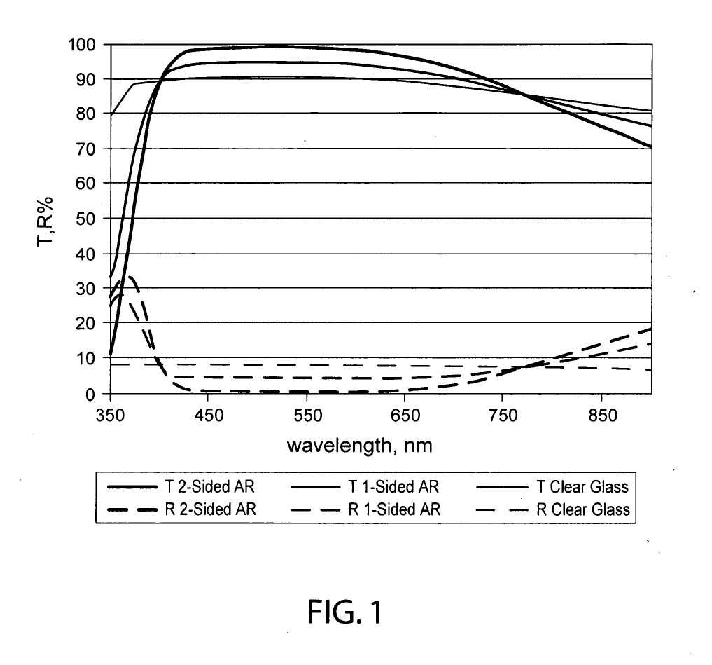

FIG. 1 shows the spectral characteristics of single-sided and double-sided antireflective coatings on clear float glass in accordance with certain example embodiments. As can be seen from these curves, an approximately 3.5% estimated boost in visible transmission is achievable when an anti-reflective coating is applied to one side of the substrate relative to clear float glass, and an approximately 7% estimated boost in visible transmission is achievable when an anti-reflective coating is applied to both sides of the substrate relative to clear float glass. The particular low-E coating used in connection with the FIG. 1 example is the ThermaGuard AR coating commercial available from the assignee of the instant invention. See, for example, U.S. application Ser. Nos. 12/923,146; 12/379,382; 12/458,791; and 12/458,790, each of which is hereby incorporated herein in its entirety, for example AR coatings that may be used in connection with embodiments of this invention.

Example ranges for the thicknesses of each layer in an example AR coating are as follows:

TABLE 1
(Example Materials/Thicknesses)

| Layer | Range (nm) | More Preferred (nm) | Example (nm) |
|---|---|---|---|
| SiOₓN_{y} | 75-135 nm | 94-115 nm | 95 nm |
| TiOₓ | 10-35 nm | 12-22 nm | 21 nm |
| SiOₓ | 70-130 nm | 89-109 nm | 105 nm |

The following tables show the as coated to heat treated color shifts for the single sided and double sided AR coatings on low-iron glass. It will be appreciated that the heat treatment processes have a reduced (and sometimes no) appreciable impact on the aesthetic (e.g., reflected color) quality of the coating. The example coatings described herein have purple hues as deposited, for example. The example purple hue is maintained after heat treatment. This is particularly desirable in a number of applications, where aesthetic quality in terms of reflected color is correspondingly desired.

### Example Single-Sided AR Average Color Readings

| | L* | a* | b* | Y |
|---|---|---|---|---|
| SS Bake Trans | 97.92 | −0.92 | 0.77 | 94.72 |
| SS Bake Glass | 25.96 | 3.99 | −3.93 | 4.73 |
| SS Bake Film | 25.80 | 3.94 | −3.95 | 4.68 |
| SS Trans | 97.56 | −0.83 | 1.19 | 93.82 |
| SS Glass | 26.34 | 2.75 | −3.46 | 4.86 |
| SS Film | 26.02 | 2.75 | −3.30 | 4.75 |

### Example Single-Sided AR Predicted Color Shifts During Bake

| | ΔL* | Δa* | Δb* | ΔY | ΔE |
|---|---|---|---|---|---|
| Transmission | 0.37 | −0.09 | −0.43 | 0.91 | 0.57 |
| Glass | −0.38 | 1.24 | −0.47 | −0.13 | 1.38 |
| Film | −0.22 | 1.20 | −0.65 | −0.07 | 1.38 |

### Example Double-Sided AR Average Color Readings

| | L* | a* | b* | Y |
|---|---|---|---|---|
| DS Bake Trans | 99.47 | −1.53 | 1.42 | 98.63 |
| DS Bake Glass | 6.08 | 24.93 | −19.38 | 0.75 |
| DS Bake Film | 6.11 | 24.91 | −19.30 | 0.76 |
| DS Trans | 99.12 | −1.36 | 2.02 | 97.74 |
| DS Glass | 6.36 | 19.13 | −16.87 | 0.79 |
| DS Film | 6.42 | 19.31 | −16.98 | 0.80 |

### Example Double-Sided AR Predicted Color Shifts During Bake

| | ΔL* | Δa* | Δb* | ΔY | ΔE |
|---|---|---|---|---|---|
| Transmission | 0.35 | −0.17 | −0.59 | 0.89 | 0.71 |
| Glass | −0.27 | 5.80 | −2.50 | −0.04 | 6.32 |
| Film | −0.31 | 5.60 | −2.32 | −0.04 | 6.07 |

Similar to the above, low-E coatings may be provided to one or both surfaces of any one or more of the substrates. For example, in connection with a refrigerator door including two IGUs (and thus three glass substrates), low-E coatings may be applied to any one or more of the six surfaces thereof. A silver-based low-E coating suitable for certain example embodiments of this invention may be any one of the low-E coatings described in U.S. Publication Nos. 2009/0214880; 2009/0205956; 2010/0075155; and 2010/0104840, as well as U.S. application Ser. No. 12/662,561, the entire contents of which are hereby incorporated herein by reference. Example low-E coatings having split silver layers are described in, for example, U.S. application Ser. No. 12/453,125, as well as U.S. Publication No. 2009/0324934, the entire contents of each of which are hereby incorporated herein by reference.

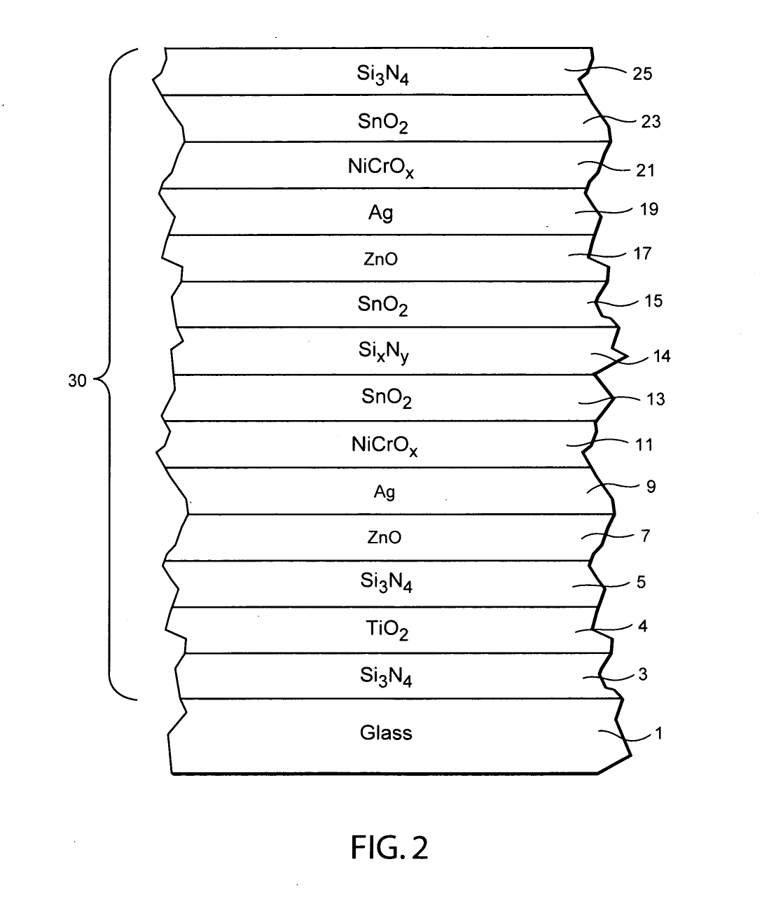

An example low-E coating will now be discussed in connection with FIG. 2, which is a cross-sectional view of an article supporting a low-E coating according to an example embodiment of this invention. The coated article includes substrate 1 (e.g., clear, green, bronze, or blue-green glass substrate from about 1.0 to 10.0 mm thick, more preferably from about 1.0 mm to 4.4 mm thick), and low-E coating (or layer system) 30 provided on the substrate 1 either directly or indirectly. The coating (or layer system) 30 includes, for example: bottom dielectric silicon nitride layer 3 which may be Si₃N₄, of the Si-rich type for haze reduction, or of any other suitable stoichiometry silicon nitride in different embodiments of this invention, color tuning titanium oxide based layer 4 (e.g., of or including TiO₂ or the like), optional additional dielectric silicon nitride layer 5 which may be Si₃N₄, of the Si-rich type for haze reduction, or of any other suitable stoichiometry silicon nitride, first lower contact layer 7 (which contacts bottom IR reflecting layer 9), first conductive and preferably metallic infrared (IR) reflecting layer 9, first upper contact layer 11 (which contacts layer 9), dielectric layer 13 (which may be deposited in one or multiple steps in different embodiments of this invention), another silicon nitride based and/or inclusive layer 14, tin oxide inclusive based and/or inclusive interlayer 15, second lower contact layer 17 (which contacts IR reflecting layer 19), second conductive and preferably metallic IR reflecting layer 19, second upper contact layer 21 (which contacts layer 19), dielectric layer 23, and finally protective dielectric layer 25. The “contact” layers 7, 11, 17, and 21 each contact at least one IR reflecting layer (e.g., layer based on Ag). The aforesaid layers 3-25 make up low-E coating 30 that is provided on glass or plastic substrate 1.

While various thicknesses and materials may be used in layers in different embodiments of this invention, example thicknesses and materials for the respective layers on the glass substrate 1 in the FIG. 2 embodiment are as follows, from the glass substrate outwardly (an example of the titanium oxide based layer is about 80 angstroms):

### Example Materials/Thicknesses; FIG. 2 Embodiment

| | Preferred | | More | | | |
|---|---|---|---|---|---|---|
| Layer | Range (\acute{Å}) | | Preferred (\acute{Å}) | | Example (Å) | |
| Glass (1-10 mm thick) | | | | | | |
| SiₓN_{y} (layer 3) | 40-250 | Å | 125-175 | Å | 150 | Å |
| TiOₓ (layer 4) | 40-400 | Å | 50-200 | Å | 70-120 | Å |
| SiₓN_{y} (optional layer 5) | 40-450 | Å | 50-150 | Å | 75 | Å |
| ZnOₓ (layer 7) | 10-300 | \acute{Å} | 50-85 | \acute{Å} | 70 | Å |
| Ag (layer 9) | 100-180 | \acute{Å} | 125-160 | \acute{Å} | 139 | Å |
| NiCrOₓ (layer 11) | 4-14 | \acute{Å} | 4-12 | \acute{Å} | 5 | Å |
| SnO₂ (layer 13) | 0-1,000 | Å | 200-700 | Å | 585 | Å |
| SiₓN_{y} (layer 14) | 50-450 | \acute{Å} | 60-100 | \acute{Å} | 80 | Å |
| SnO₂ (layer 15) | 30-250 | Å | 50-200 | Å | 109 | Å |
| ZnOₓ (layer 17) | 10-300 | \acute{Å} | 40-150 | \acute{Å} | 96 | Å |
| Ag (layer 19) | 130-220 | \acute{Å} | 140-200 | \acute{Å} | 169 | Å |
| NiCrOₓ (layer 21) | 4-14 | \acute{Å} | 4-12 | \acute{Å} | 5 | Å |
| SnO₂ (layer 23) | 0-750 | Å | 40-200 | Å | 127 | Å |
| Si₃N₄ (layer 25) | 0-750 | \acute{Å} | 80-320 | \acute{Å} | 215 | Å |

In certain example embodiments of this invention, coated articles herein may have the following optical and solar characteristics set forth below when measured monolithically (before any optional HT). The sheet resistances (Rₛ) herein take into account all IR reflecting layers (e.g., silver based layers 9, 19).

Optical/Solar Characteristics (Monolithic; no-HT)

| Characteristic | General | More Preferred | Most Preferred |
|---|---|---|---|
| Rₛ (ohms/sq.): | <=2.5 | <=2.1 | <=1.9 (or <=1.8) |
| Eₙ: | <=0.06 | <=0.03 | <=0.025 |
| Tᵥᵢₛ (Ill. C 2°): | >=60% | >=65% | >=70 or 72% |
| a*ₜ (Ill. C 2°): | −6 to +1.0 | −5 to −3.0 | −4.2 to −4.0 |
| b*ₜ (Ill. C 2°): | −2.0 to +4.0 | 0.0 to 2.0 | 0.5 to 1.7 |
| L* (Ill. C 2°): | 80-95 | 84-95 | 86-89 |
| R_{f}Y (Ill. C, 2 deg.): | 1 to 13% | 1 to 12% | 5-9% |
| a*_{f} (Ill. C, 2°): | −15.0 to +2.0 | −10.0 to −4.0 | −7.5 to −6.0 |
| b*_{f} (Ill. C, 2°): | −30.0 to +4.0 | −2.0 to +3.5 | 0 to 2.0 |
| L* (Ill. C 2°): | 30-45 | 32-41 | 32-34 |
| R_{g}Y (Ill. C, 2 deg.): | 1 to 14% | 1 to 13% | 5-9% |
| a*_{g} (Ill. C, 2°): | −5.0 to 0 | −4.0 to −1.0 | −3 to −1 |
| b*_{g} (Ill. C, 2°): | −14.0 to 0 | −13.0 to −7.0 | −12 to −8 |
| L* (Ill. C 2°): | 30-40 | 31-35 | 32-33 |

Optical/Solar Characteristics (Monolithic; post-HT [e.g., tempered])

| Characteristic | General | More Preferred | Most Preferred |
|---|---|---|---|
| Rₛ (ohms/sq.): | <=2.5 | <=2.1 | <=1.9 (or <=1.8) |
| Eₙ: | <=0.06 | <=0.03 | <=0.025 |
| Tᵥᵢₛ (Ill. C 2°): | >=65% | >=70% | >=72 or 73% |
| a*ₜ (Ill. C 2°): | −6 to +1.0 | −5 to −3.0 | −4.8 to −4.4 |
| b*ₜ (Ill. C 2°): | −2.0 to +5.0 | 0.0 to 4.0 | 1.0 to 3.5 |
| L* (Ill. C 2°): | 80-95 | 84-95 | 86-89 |
| R_{f}Y (Ill. C, 2 deg.): | 1 to 13% | 1 to 12% | 5-9% |
| a*_{f} (Ill. C, 2°): | −15.0 to +2.0 | −10.0 to −4.0 | −7.5 to −6.0 |
| b*_{f} (Ill. C, 2°): | −30.0 to +4.0 | −4.0 to −0.5 | −3.5 to −1.5 |
| L* (Ill. C 2°): | 30-45 | 32-41 | 29-32 |
| R_{g}Y (Ill. C, 2 deg.): | 1 to 14% | 1 to 13% | 5-9% |
| a*_{g} (Ill. C, 2°): | −5.0 to 0 | −4.0 to +1.0 | −2 to +0.5 |
| b*_{g} (Ill. C, 2°): | −14.0 to 0 | −13.0 to −8.0 | −12 to −9 |
| L* (Ill. C 2°): | 30-40 | 31-35 | 30-32 |

In view of the foregoing, it will be appreciated that some example low-E stacks may include first and second infrared (IR) reflecting layers comprising silver, wherein said IR reflecting layers are spaced apart from one another by at least one dielectric layer that is located therebetween, and wherein the first IR reflecting layer is located closer to the glass substrate than is the second IR reflecting layer. A bottom dielectric stack may be provided between the first IR reflecting layer and the glass substrate, wherein the bottom dielectric stack comprises moving away from the glass substrate a first layer comprising silicon nitride, a layer comprising titanium oxide and/or niobium oxide, and a dielectric layer, and wherein the layer comprising titanium oxide and/or niobium oxide is located between and directly contacting the first layer comprising silicon nitride and the dielectric layer. A contact layer comprising NiCr may be located over and directly contacting at least one of the IR reflecting layers comprising silver, wherein the contact layer comprising NiCr is from about 4-14 Å thick. A coated article with one such stack may have a visible transmission of at least about 60%. Of course, as indicated above, this is but one example low-E coating and other low-E coatings may be used in connection with different example embodiments of this invention.

To further boost the light transmission through the refrigerator door, low-iron substrates may be used on any one or more panes thereof. A variety of low-iron substrates are known and often are used in connection with solar photovoltaic applications. Example low-iron glass substrates are disclosed, for example, in U.S. application Ser. No. 12/385,318, as well as in U.S. Publication Nos. 2006/0169316; 2006/0249199; 2007/0215205; 2009/0223252; 2010/0122728; and 2009/0217978, the entire contents of each of which are hereby incorporated herein by reference. Example details of a low iron substrate will now be provided.

The total amount of iron present is expressed herein in terms of Fe₂O₃ in accordance with standard practice. However, typically, not all iron is in the form of Fe₂O₃. Instead, iron is usually present in both the ferrous state (Fe²⁺; expressed herein as FeO, even though all ferrous state iron in the glass may not be in the form of FeO) and the ferric state (Fe³⁺). Iron in the ferrous state (Fe²⁺; FeO) is a blue-green colorant, while iron in the ferric state (Fe³⁺) is a yellow-green colorant. The blue-green colorant of ferrous iron (Fe²⁺; FeO) is of particular concern when seeking to achieve a fairly clear or neutral colored glass, since as a strong colorant it introduces significant color into the glass. While iron in the ferric state (Fe³⁺) is also a colorant, it is of less concern when seeking to achieve a glass fairly clear in color since iron in the ferric state tends to be weaker as a colorant than its ferrous state counterpart.

In certain example embodiments of this invention, a glass is made so as to be highly transmissive to visible light, to be fairly clear or neutral in color, and to consistently realize high % TS values. High % TS values are particularly desirable for photovoltaic device applications in that high % TS values of the light-incident-side glass substrate permit such photovoltaic devices to generate more electrical energy from incident radiation since more radiation is permitted to reach the semiconductor absorbing film of the device, but they are not known to be incorporated into refrigerator/freezer door applications. In other words, although some low iron glass has been used in connection with photovoltaic device applications, the inventors of the instant invention have realized that it could also be used in connection with refrigerator/freezer door applications. It has been found that the use of an extremely high batch redox in the glass manufacturing process permits resulting low-ferrous glasses made via the float process to consistently realize a desirable combination of high visible transmission, substantially neutral color, and high total solar (% TS) values. Moreover, in certain example embodiments of this invention, this technique permits these desirable features to be achieved with the use of little or no cerium oxide.

In certain example embodiments of this invention, a soda-lime-silica based glass is made using the float process with an extremely high batch redox. An example batch redox which may be used in making glasses according to certain example embodiments of this invention is from about +26 to +40, more preferably from about +27 to +35, and most preferably from about +28 to +33 (note that these are extremely high batch redox values not typically used in making glass). In making the glass via the float process or the like, the high batch redox value tends to reduce or eliminate the presence of ferrous iron (Fe²⁺; FeO) in the resulting glass, thereby permitting the glass to have a higher % TS transmission value which also may be beneficial in commercial refrigeration applications. This is advantageous, for example, in that it permits high transmission, neutral color, high % TS glass to be made using raw materials having typical amounts of iron in certain example instances (e.g., from about 0.04 to 0.10% total iron). In certain example embodiments of this invention, the glass has a total iron content (Fe₂O₃) of no more than about 0.1%, more preferably from about 0 (or 0.04) to 0.1%, even more preferably from about 0.01 (or 0.04) to 0.08%, and most preferably from about 0.03 (or 0.04) to 0.07%. In certain example embodiments of this invention, the resulting glass may have a % FeO (ferrous iron) of from 0 to 0.0050%, more preferably from 0 to 0.0040, even more preferably from 0 to 0.0030, still more preferably from 0 to 0.0020, and most preferably from 0 to 0.0010, and possibly from 0.0005 to 0.0010 in certain example instances. In certain example embodiments, the resulting glass has a glass redox (different than batch redox) of no greater than 0.08, more preferably no greater than 0.06, still more preferably no greater than 0.04, and even more preferably no greater than 0.03 or 0.02.

In certain example embodiments, the glass substrate may have fairly clear color that may be slightly yellowish (a positive b* value is indicative of yellowish color), in addition to high visible transmission and high % TS. For example, in certain example embodiments, the glass substrate may be characterized by a visible transmission of at least about 90% (more preferably at least about 91%), a total solar (% TS) value of at least about 90% (more preferably at least about 91%), a transmissive a* color value of from −1.0 to +1.0 (more preferably from −0.5 to +0.5, even more preferably from −0.35 to 0), and a transmissive b* color value of from −0.5 to +1.5 (more preferably from 0 to +1.0, and most preferably from +0.2 to +0.8). These properties may be realized at an example non-limiting reference glass thickness of about 4 mm.

In certain example embodiments of this invention, there is provided a method of making glass comprising:

| Ingredient | wt. % |
|---|---|
| SiO₂ | 67-75% |
| Na₂O | 10-20% |
| CaO | 5-15% |
| total iron (expressed as Fe₂O₃) | 0.001 to 0.1% |
| % FeO | 0 to 0.005 |

wherein the glass has visible transmission of at least about 90%, a transmissive a* color value of −1.0 to +1.0, a transmissive b* color value of from −0.50 to +1.5, % TS of at least 89.5%, and wherein the method comprises using a batch redox of from +26 to +40 in making the glass.

In certain example embodiments of this invention, there is provided a glass comprising:

| Ingredient | wt. % |
|---|---|
| SiO₂ | 67-75% |
| Na₂O | 10-20% |
| CaO | 5-15% |
| total iron (expressed as Fe₂O₃) | <=0.1% |
| % FeO | <=0.005 |
| glass redox | <=0.08 |
| antimony oxide | 0 to less than 0.01% |
| cerium oxide | 0 to 0.07% |

wherein the glass has visible transmission of at least 90%, TS transmission of at least 90%; a transmissive a* color value of −1.0 to +1.0, a transmissive b* color value of from −0.5 to +1.5.

In still further example embodiments of this invention, there is provided a coated article comprising: a glass substrate; first and second conductive layers with at least a photoelectric film provided therebetween; wherein the glass substrate is of a composition comprising:

| Ingredient | wt. % |
|---|---|
| SiO₂ | 67-75% |
| Na₂O | 10-20% |
| CaO | 5-15% |
| total iron (expressed as Fe₂O₃) | <=0.1% |
| % FeO | <=0.005 |
| glass redox | <=0.08 |
| antimony oxide | 0 to less than 0.01% |
| cerium oxide | 0 to 0.07% |

wherein the glass substrate has visible transmission of at least 90%, TS transmission of at least 90%; a transmissive a* color value of −1.0 to +1.0, a transmissive b* color value of from −0.5 to +1.5.

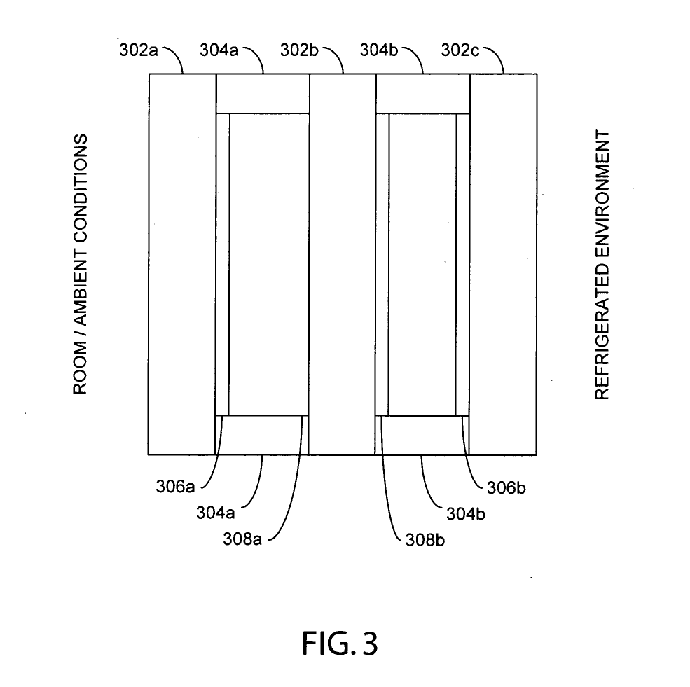

FIG. 3 is an example refrigerator/freezer door in accordance with an example embodiment. FIG. 3 includes first, second, and third substrates 302a, 302b, and 302c. In certain example embodiments, all three substrates may be low-iron substrates. In certain other example embodiments, the center pane may be a low-iron substrate and the outer two substrates may be float glass substrates. The substrates may, however, be “mixed and matched” between float glass and low-iron substrates in different example embodiments. In certain example embodiments, no low-iron substrates may be provided, and in certain other example embodiments, only low-iron substrates may be provided.

As shown in FIG. 3, first and second low-E coatings 306a and 306b are provided on inner surfaces of the outer substrates so that they effectively face one another. Also as shown in FIG. 3, first and second antireflective coatings 308a and 308b are provided on both major surfaces of the center pane 302b. Of course, as noted above, low-E and antireflective coatings may be provided to any one or more surfaces in different embodiments of this invention. In certain example embodiments, the low-E and antireflective coatings may be sputter-deposited coatings.

Warm-edge spacers 304a and 304b may be provided around the periphery of the substrates, e.g., so as to help maintain them in substantially parallel spaced apart relation to one another. An inert gas such as argon, xenon, krypton, or the like may be made to occupy the areas between adjacent substrates in certain example embodiments.

In certain example embodiments, to further improve the thermal efficiency of the door, the cavities between the adjacent substrates may be at least partially evacuated to a pressure less than atmospheric such that, for example, vacuum insulated glass (VIG) units are provided. The partially evacuated cavities may be filled with an inert gas such as, for example, argon, xenon, krypton, or the like. A plurality of pillars (not shown in FIG. 3) also may help to maintain the substrates in substantially parallel spaced apart relation to one another. Vacuum insulating glass (VIG) units are known in the art. For example, see U.S. Pat. Nos. 5,664,395; 5,657,607; and 5,902,652, U.S. Publication Nos. 2009/0151854; 2009/0151855; 2009/0151853; 2009/0155499; and 2009/0155500, and U.S. application Ser. Nos. 12/453,220 and 12/453,221, the disclosures of which are all hereby incorporated herein by reference.

The tradeoffs of current technology in terms of increased thermal insulation (e.g., higher R-values) and reduced light transmission is shown in the table below.

| | | Solar | | | | | | | |
|---|---|---|---|---|---|---|---|---|---|
| | | Energy | | | | | | | |
| | Visible | (Direct) | | Winter | Summer | | | | |
| | Light | | % R | U-factor | U-Factor | Shading | | Relative | |
| Configuration | % T | % T | Out | Night | Day | Coef. | SHGC | Gain | R-value |
| Triple IGU, 3 | 75 | 63 | 18 | 0.31 | 0.35 | 0.81 | 0.702 | 167 | 3.185 |
| float, no low-E | | | | | | | | | |
| Triple IGU, 3 | 63 | 30 | 41 | 0.22 | 0.23 | 0.39 | 0.336 | 80 | 4.64 |
| float, 1 low-E | | | | | | | | | |
| Triple IGU, 3 | 53 | 22 | 41 | 0.16 | 0.17 | 0.36 | 0.311 | 74 | 6.214 |
| float, 2 low-E | | | | | | | | | |
| Triple IGU, 2 | 55 | 23 | 42 | 0.16 | 0.17 | 0.36 | 0.313 | 74 | 6.214 |
| float, 1 low- | | | | | | | | | |
| Fe, two low-E | | | | | | | | | |
| Triple IGU, 2 | 58.5 | 23 | 42 | 0.16 | 0.17 | 0.36 | 0.313 | 74 | 6.214 |
| float, 1 low- | | | | | | | | | |
| Fe, two low- | | | | | | | | | |
| E, 1 AR | | | | | | | | | |
| Triple IGU, 2 | 62 | 23 | 42 | 0.16 | 0.17 | 0.36 | 0.313 | 74 | 6.214 |
| float, 1 low | | | | | | | | | |
| Fe, 2 low-E, | | | | | | | | | |
| 2 AR | | | | | | | | | |

The values in the table above were calculated using National Fenestration Rating Council technical standard NFRC 100-2004. All configurations in the table used 3.1 mm glass spaced 8 mm apart. The cavities between adjacent glass substrates were filled with argon. A split silver low-E coating was used as the low-E coatings where noted above. ThermaGuard AR was used as antireflective coating where noted above.

Although certain example embodiments have been described in connection with refrigerator doors, the techniques described herein may be applied to other structures. For example, the techniques of certain example embodiments may be applied to freezer doors, etc. Such applications may be horizontally oriented, vertically oriented, etc. Furthermore, the example embodiments described herein may be used in connection with so-called active heating/defogging/defrosting applications, applications where thin film layer stacks are provided to provide low hemispherical emissivity coatings in connection with more passive solutions, etc. See, for example, U.S. application Ser. Nos. 12/659,196 and 12/458,790; the entire contents of each of which are hereby incorporated herein by reference.

“Peripheral” and “edge” seals herein do not mean that the seals are located at the absolute periphery or edge of the unit, but instead mean that the seal is at least partially located at or near (e.g., within about two inches) an edge of at least one substrate of the unit. Likewise, “edge” as used herein is not limited to the absolute edge of a glass substrate but also may include an area at or near (e.g., within about two inches) of an absolute edge of the substrate(s).

As used herein, the terms “on,” “supported by,” and the like should not be interpreted to mean that two elements are directly adjacent to one another unless explicitly stated. In other words, a first layer may be said to be “on” or “supported by” a second layer, even if there are one or more layers therebetween.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A refrigerator/freezer door, comprising:
first, second, and third glass substrates;
a first edge seal provided at a periphery of the first and/or second substrate(s) to help maintain the first and second substrates in substantially parallel, spaced apart relation to one another;
a second edge seal provided at a periphery of the second and/or third substrate(s) to help maintain the second and third substrates in substantially parallel, spaced apart relation to one another;
first and second antireflective coatings respectively supported by first and second major surfaces of the second substrate; and
first and second low-E coatings respectively supported by major surfaces of the first and third substrates that face the second substrate,
wherein at least one of the first, second, and third glass substrates is a low-iron substrate.

2. The refrigerator/freezer door of claim 1, wherein gaps between adjacent substrates are at least partially filled with argon.

3. The refrigerator/freezer door of claim 1, wherein the refrigerator/freezer door has a visible transmission of at least about 55%.

4. The refrigerator/freezer door of claim 1, wherein the refrigerator/freezer door has a visible transmission of at least about 60%.

5. The refrigerator/freezer door of claim 1, wherein the refrigerator/freezer door has a visible transmission of at least about 62%.

6. The refrigerator/freezer door of claim 1, wherein the glass used for each said low-iron substrate comprises the following ingredients at the following weight percentages:

| Ingredient | wt. % |
|---|---|
| SiO₂ | 67-75% |
| Na₂O | 10-20% |
| CaO | 5-15% |
| total iron (expressed as Fe₂O₃) | 0.001 to 0.1% |
| % FeO | 0 to 0.005 |

wherein the glass has a visible transmission of at least about 90%, a transmissive a* color value of −1.0 to +1.0, and a transmissive b* color value of from −0.50 to +1.5.

7. The refrigerator/freezer door of claim 6, wherein each said low-iron substrate is essentially free from any other colorants.

8. The refrigerator/freezer door of claim 1, wherein the glass used for each said low-iron substrate comprises the following ingredients at the following weight percentages:

| Ingredient | wt. % |
|---|---|
| SiO₂ | 67-75% |
| Na₂O | 10-20% |
| CaO | 5-15% |
| total iron (expressed as Fe₂O₃) | <=0.1% |
| % FeO | <=0.005 |
| glass redox | <=0.08 |
| antimony oxide | 0 to less than 0.01% |
| cerium oxide | 0 to 0.07% |

wherein the glass has a visible transmission of at least 90%, a transmissive a* color value of −1.0 to +1.0, and a transmissive b* color value of from −0.5 to +1.5.

9. The refrigerator/freezer door of claim 1, wherein at least two of the first, second, and third glass substrates are low-iron substrates.

10. The refrigerator/freezer door of claim 1, wherein the first and second low-E coatings each comprise first and second infrared (IR) reflecting layers comprising silver, wherein said IR reflecting layers are spaced apart from one another by at least one dielectric layer that is located therebetween, and wherein the first IR reflecting layer is located closer to the glass substrate than is the second IR reflecting layer.

11. The refrigerator/freezer door of claim 1, wherein the first and second low-E coatings each further comprise:
a bottom dielectric stack provided between the first IR reflecting layer and the glass substrate, wherein the bottom dielectric stack comprises moving away from the glass substrate a first layer comprising silicon nitride, a layer comprising titanium oxide, and a dielectric layer, and wherein the layer comprising titanium oxide is located between and directly contacting the first layer comprising silicon nitride and the dielectric layer; and
a contact layer comprising NiCr located over and directly contacting at least one of the IR reflecting layers comprising silver, wherein the contact layer comprising NiCr is from about 4-14 Å thick.

12. A refrigerator/freezer door, comprising:
first, second, and third glass substrates;
a first edge seal provided at a periphery of the first and/or second substrate(s) to help maintain the first and second substrates in substantially parallel, spaced apart relation to one another;
a second edge seal provided at a periphery of the second and/or third substrate(s) to help maintain the second and third substrates in substantially parallel, spaced apart relation to one another;
at least one antireflective coating, each said antireflective coating being supported by one major surface of the second substrate; and
at least one low-E coating, each said low-E coating being supported by one major surface of the first or third substrate,
wherein at least one of the first, second, and third glass substrates comprises low-iron glass including the following ingredients at the following weight percentages:

| Ingredient | wt. % |
|---|---|
| SiO₂ | 67-75% |
| Na₂O | 10-20% |
| CaO | 5-15% |
| total iron (expressed as Fe₂O₃) | 0.001 to 0.1% |
| % FeO | 0 to 0.005 |

wherein the low-iron glass has a visible transmission of at least about 90%, a transmissive a* color value of −1.0 to +1.0, and a transmissive b* color value of from −0.50 to +1.5, and
wherein the refrigerator/freezer door has a visible transmission of at least about 55%.

13. A method of making a refrigerator/freezer door, the method comprising:
providing first, second, and third glass substrates;
disposing first and second antireflective coatings, directly or indirectly, on first and second major surfaces of the second substrate, respectively;
disposing first and second low-E coatings, directly or indirectly, on major surfaces of the first and third substrates that face the second substrate, respectively;
providing a first edge seal at a periphery of the first and/or second substrate(s) to help maintain the first and second substrates in substantially parallel, spaced apart relation to one another; and
providing a second edge seal at a periphery of the second and/or third substrate(s) to help maintain the second and third substrates in substantially parallel, spaced apart relation to one another,
wherein at least one of the first, second, and third glass substrates is a low-iron substrate.

14. The method of claim 13, wherein gaps between adjacent substrates are at least partially filled with argon.

15. The method of claim 13, wherein the refrigerator/freezer door has a visible transmission of at least about 55%.

16. The method of claim 13, wherein the glass used for each said low-iron substrate comprises the following ingredients at the following weight percentages:

| Ingredient | wt. % |
|---|---|
| SiO₂ | 67-75% |
| Na₂O | 10-20% |
| CaO | 5-15% |
| total iron (expressed as Fe₂O₃) | 0.001 to 0.1% |
| % FeO | 0 to 0.005 |

wherein the glass has a visible transmission of at least about 90%, a transmissive a* color value of −1.0 to +1.0, and a transmissive b* color value of from −0.50 to +1.5.

17. The method of claim 16, wherein each said low-iron substrate is essentially free from any other colorants.

18. The method of claim 13, wherein at least two of the first, second, and third glass substrates are low-iron substrates.

19. The method of claim 13, wherein the first and second low-E coatings each comprise first and second infrared (IR) reflecting layers comprising silver, wherein said IR reflecting layers are spaced apart from one another by at least one dielectric layer that is located therebetween, and wherein the first IR reflecting layer is located closer to the glass substrate than is the second IR reflecting layer.

20. The method of claim 13, wherein the first and second low-E coatings each further comprise:
a bottom dielectric stack provided between the first IR reflecting layer and the glass substrate, wherein the bottom dielectric stack comprises moving away from the glass substrate a first layer comprising silicon nitride, a layer comprising titanium oxide, and a dielectric layer, and wherein the layer comprising titanium oxide is located between and directly contacting the first layer comprising silicon nitride and the dielectric layer; and
a contact layer comprising NiCr located over and directly contacting at least one of the IR reflecting layers comprising silver, wherein the contact layer comprising NiCr is from about 4-14 Å thick.
